(19) United States
(12) Patent Application Publication
(10) Pub. No.: US 2002/0080439 A1
(43) Pub. Date: Jun. 27, 2002

(54) System for attaching broadband test point within HFC network

(75) Inventors: Dean Stoneback, Souderton, PA (US); Jay Strater, Jamison, PA (US); Richard Gresko, Huntington Valley, PA (US)

Correspondence Address: VOLPE AND KOENIG, PC, DEPT MOT, SUITE 400, ONE PENN CENTER, 1617 JOHN F. KENNEDY BOULEVARD, PHILADELPHIA, PA, 19103, US

(73) Assignee: General Instrument Corporation, Horsham, PA (US)

(21) Appl. No.: 10/017,062

(22) Filed: Dec. 14, 2001

Related U.S. Application Data
(60) Provisional application No. 60/255,691, filed on Dec. 14, 2000.

(51) Int. Cl. H04B 10/08; G02B 6/28

(52) U.S. Cl. 359/110; 359/112; 385/24

(57) ABSTRACT

A system for monitoring ingress in a bi-directional HFC network having a domain manager located at the hub to monitor the status of the network, a fiber-optic trunk, and a series of nodes located along the trunk is provided. The monitoring system comprises a BTP (Broadband Test Point) located at a tap, integrated into a node or amplifier, or strand-mounted as a stand-alone device. The BTP includes an ingress monitoring interface connected to the HFC network through a downstream-facing directional coupler to detect ingress in the network downstream from the interface, and a modem connected to the network through an upstream-facing directional coupler. The modem is in communication with the domain manager to transmit detected ingress information.

### CROSS-REFERENCE TO RELATED APPLICATION

This application claims the benefit of U.S. Provisional Patent Application No. 60/255,691, filed Dec. 14, 2000, entitled “Method of Attaching a Broadband Test Point in HFC Network.”

### BACKGROUND OF THE INVENTION

The present invention relates generally to a bidirectional cable television (CATV) network and, more particularly, to a method and apparatus for attaching broadband test points (BTP) within the network to monitor ingress noise in the network

FIG. 1 is a block diagram of a portion of a typical bi-directional CATV network using modems for data transmissions. It should be understood that the network 10 shown in FIG. 1 is included to aid in the explanation of the present invention and is merely exemplary of the many CATV network configurations. The network 10 originates at a hub 12 and terminates at subscriber cable modems 26. In larger networks, a headend services a number of hubs. In smaller networks, the network may terminate at the hub 12, in which case the hub 12 itself is the headend. Hub 12 typically contains a modem termination system that transmits and receives data from subscriber modems 26. The hub 12 is connected to a distribution node 16 through a fiber-optic line 14. A hub 12 can typically support up to 80 distribution nodes 16. Each of the nodes 16 is typically connected to a number of bi-directional amplifiers 20 by coaxial cable branch lines 18. Each bi-directional amplifier 20 is, in turn, connected to at least one tap 22. Each tap 22 is ultimately connected to the modems 26 by coaxial cable drop lines 24. Other cable devices, such as set top boxes, televisions, and embedded media terminal adapters may be present at the downstream end of the network 10 in addition to or instead of modems 26.

As used herein, the term “upstream” refers to: (1) parts of the network 10 located between a reference point on the network and the hub 12, and (2) signals in the network travelling in the direction of the hub 12. Conversely, “downstream” refers to: (1) parts of the network 10 located between a reference point and cable modems 26, and (2) signals in the network travelling away from the hub 12.

CATV networks of this type are commonly referred to hybrid fiber-coaxial (HFC) networks or plants because they include a combination of fiber-optic lines (usually located between the hub 12 and the nodes 16) and coaxial cable lines (usually located downstream from the nodes 16). The terms CATV network, CATV plant, HFC network and HFC plant are used interchangeably herein and should be understood to generally refer to a network of the type described above and shown in FIG. 1.

Ingress noise remains a problem in HFC networks. Ingress noise can be introduced from many sources, such as RF emissions from electrical appliances used near open or loose cable connections in residences, radio transmissions on the network cables, and RF interference from electrical devices entering via cable ground, for example. Ideally, such noise could be dramatically reduced or eliminated by replacing the coaxial portions of HFC networks with fiber-optic lines. However, conversion of entire HFC networks to fiber optic technology is not economically feasible at this time. Ingress noise in the upstream direction is particularly problematic because ingress in drop lines 24 and branches 28 accumulates as data moves upstream to the hub 12. The first step in blocking or reducing such ingress is identifying which part of the network 10 in the source of the ingress noise.

Currently, ingress noise is continuously monitored only at the hub 12, or at a headend in larger networks. When ingress noise is detected, a technician is dispatched to isolate the source of ingress by manually attaching an ingress monitoring interface to test points located at various locations along the network 10, including nodes 16, amplifiers 20 and taps 22. This method of isolating ingress in an HFC network is both time consuming and labor intensive. Therefore, a more efficient and cost effective method of locating ingress in an HFC network is needed.

### BRIEF DESCRIPTION OF THE DRAWING(S)

The present invention will hereinafter be described in conjunction with the appended drawing figure(s) wherein like numerals denote like elements, and:

FIG. 1 is a simplified block diagram showing a typical HFC network;

FIG. 2 shows a simplified block diagram of an amplifier and a tap having, in accordance with the present invention, a BTP which receives power via power passing from the tap;

FIG. 3 shows a variation of the apparatus shown in FIG. 2 wherein the BTP is located and receives power from a building;

FIG. 4 shows a simplified block diagram of a stand alone BTP spliced directly into a branch line;

FIG. 5 shows a node having a built-in BTP; and

FIG. 6 shows an amplifier having a built-in BTP.

### SUMMARY OF THE INVENTION

The present invention comprises a system for monitoring ingress in an HFC network having a hub, a domain manager located for monitoring the status of the HFC network, a fiber-optic line, and a node located along the fiber-optic line. The system includes a BTP remotely located at or downstream from the node. The BTP has an ingress monitoring interface connected to the HFC network to detect ingress in the HFC network downstream from the interface. The BTP also includes a modem in communication with the domain manager to transmit detected ingress information.

### DETAILED DESCRIPTION OF THE PREFERRED EMBODIMENT(S)

The ensuing detailed description provides preferred exemplary embodiments only, and is not intend to limit the scope, applicability, or configuration of the invention. Rather, the ensuing detailed description of the preferred exemplary embodiments will provide those skilled in the art with an enabling description for implementing a preferred exemplary embodiment of the invention. It being understood that various changes may be made in the function and arrangement of elements without departing from the spirit and scope of the invention as set forth in the appended claims.

FIG. 2 shows a first preferred embodiment of the present invention, which includes a tap 22 that has been modified to support a BTP 30. Preferably, the tap 22 is located just downstream from an amplifier 20 so that the BTP 30 can monitor all ingress sources for the branch 18 on which the tap 22 is located. The branch 18 enters the upstream end of the tap 22 and is divided by a diplexer 32 into an AC power line 34 and an RF line 36. As is conventional, the tap 22 includes an upstream-facing directional coupler 40, which is configured to pass signals back and forth in the upstream direction only. The upstream-facing directional coupler 40 is connected to a series of splitters 42, which divide the line into multiple (in this case, eight) drop lines 24, most of which are available for connection to subscriber terminals (not shown). One of the drop lines 24 is connected to a modem 62 located in the BTP 30, the function of which will be described in greater detail herein.

The tap 22 also includes a downstream-facing directional coupler 56 that is connected by a coaxial line 58 to an ingress monitoring interface 60 located in the BTP 30. The ingress monitoring interface 60 is connected to the downstream-facing directional coupler 56 to monitor ingress into the network 10 downstream from the directional coupler 56. In this embodiment the downstream-facing directional coupler 56 is preferably located upstream from the upstream-facing directional coupler 40 so that the ingress monitoring interface 60 can monitor ingress noise in the drop lines 24.

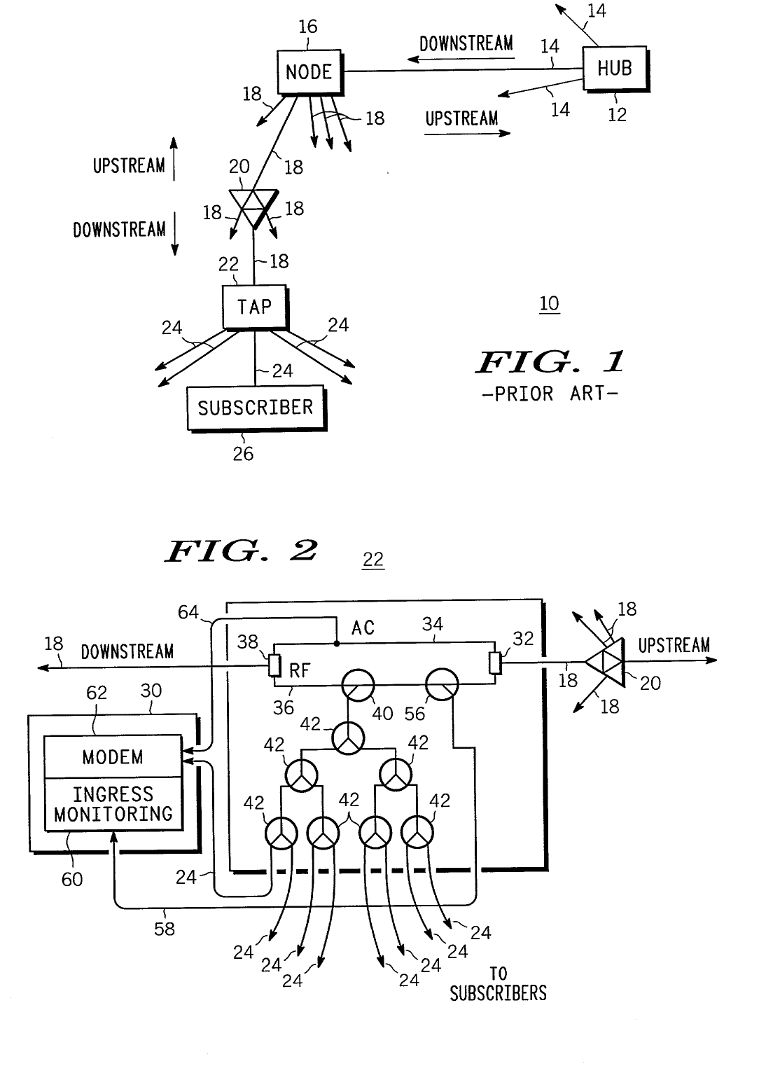

Ingress information gathered by the ingress monitoring interface 60 is communicated to the domain manager located in the hub 12 or headend (see FIG. 1) by modem 62 which sends signals upstream through the HFC network. The BTP configuration shown in FIG. 2 can be repeated at multiple points throughout the network, thereby providing real-time ingress data for a plurality of points throughout the network and enabling isolation of the ingress source(s) without the need to dispatch technicians to perform manual spot tests.

The BTP 30 may be powered by any convenient means. The preferred means for powering BTP 30 will depend upon the configuration of the network. In FIG. 2, the BTP 30 is shown receiving power via power passing from the AC line 34 through a line 64 that preferably consists of a twisted pair. Power could also be supplied to the BTP 30 by diplexing one of the coaxial lines 58, 24 feeding the ingress monitoring interface 60 and the modem 62. The BTP 30 may be mounted by any convenient means, such as strand-mounting or pedestal-mounting.

Installation of the BTP 30 at a tap 22 will ordinarily require the replacement of the existing tap face plate with a modified face plate to accommodate the downstream-facing directional coupler 56 and to possibly provide additional drop lines 24, so that the tap 22 can accommodate the modem 62 for the BTP without displacing subscribers. The modifications necessary to provide a modified face plate are within the knowledge of one having ordinary skill in the art.

The embodiment of the present invention shown in FIG. 2, is preferred for applications in which the BTP 30 is retrofitted onto existing HFC networks because it only requires replacement of tap face plates, which are relatively inexpensive components. In addition, this embodiment is unlikely to require network reconfiguration or installation of additional amplifiers because the upstream and downstream RF level drops introduced by this embodiment are likely to be within the AGC (auto gain control) capacity of the amplifier 20 immediately upstream from the tap 22.

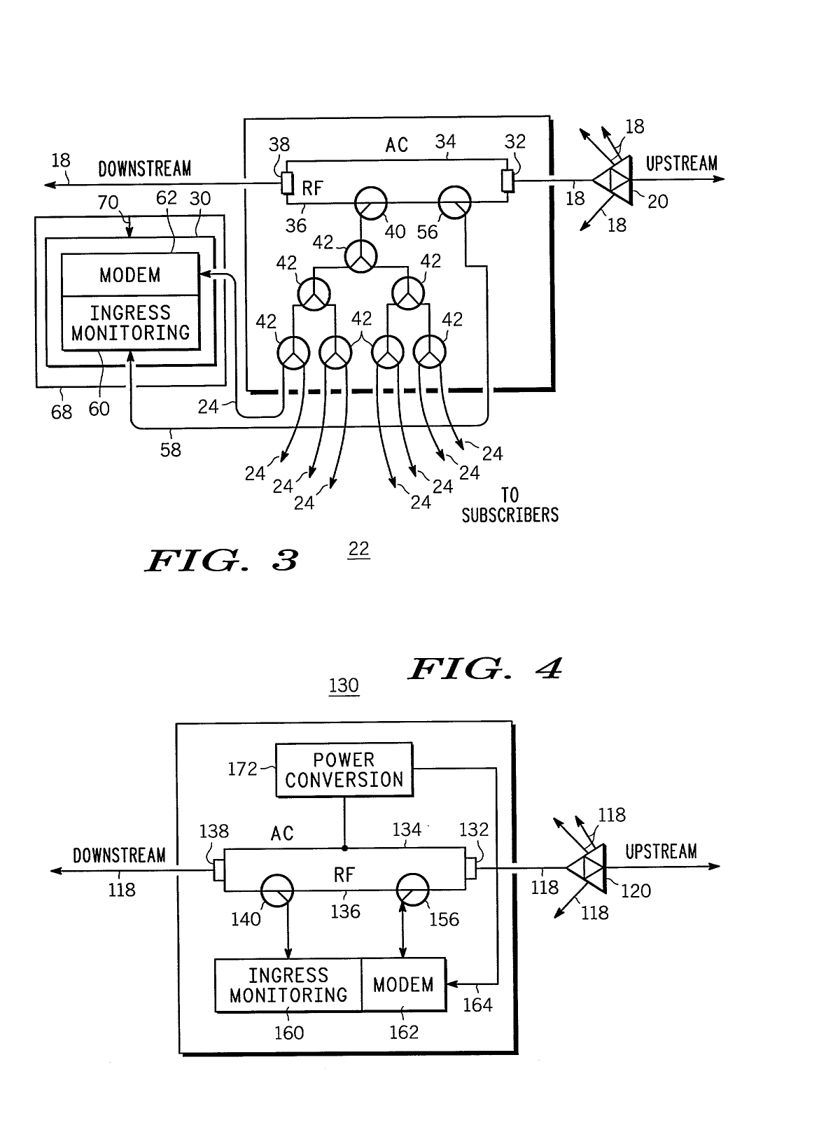

Referring now to FIG. 3, there is shown a modified version of the embodiment of the present invention shown in FIG. 2. In this embodiment, the BTP 30 is located in a building 68 which supplies power to the BTP 30 though a power line 70. This modification is suitable for limited trial use, but is less suitable for widespread, permanent deployment of the BTP 30 because it would require access to a building at every tap 22 at which a BTP 30 was to be placed.

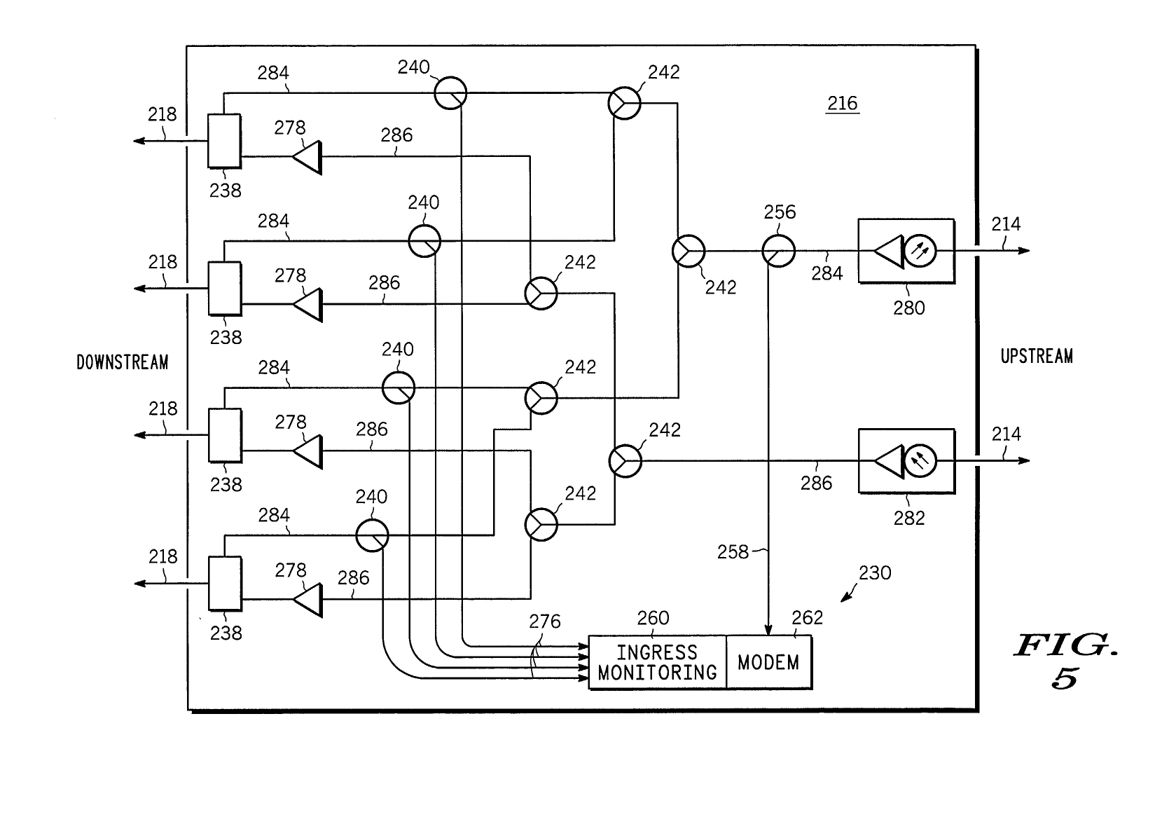

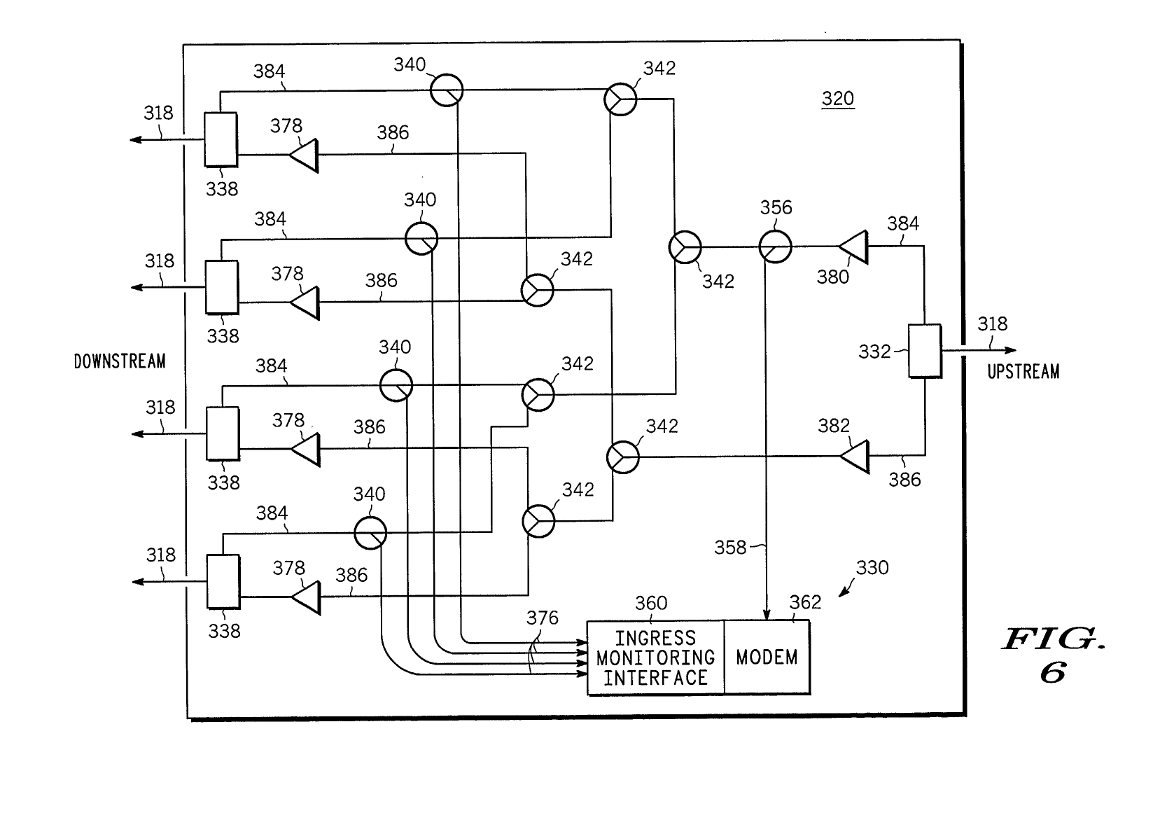

FIG. 4 shows a first alternative embodiment of the present invention in which like elements in alternative preferred embodiments are represented by reference numerals increased by factors of 100 (for example, the BTP 30 in FIG. 2 corresponds to the BTP 130 in FIG. 4 and the BTP 230 in FIG. 5). FIG. 4 shows a strand-mounted BTP 130 spliced directly into the branch 118. The branch 118 enters the BTP 130 and is divided by a diplexer 132 into an AC line 134 and an RF line 136. A downstream-facing directional coupler 140 is mounted on the RF line 136 and connected to an ingress monitoring interface 160. An upstream-facing directional coupler 156 is mounted on the RF line 136 upstream from the downstream-facing directional coupler 140 and is connected to a modem 162.

An amplifier 120 is preferably located immediately upstream from the BTP 130 to capture ingress from all sources on that branch 118 of the network. As used herein and in the claims, the term “immediately upstream from” means that there are no other components, such as taps, for example, located on the branch 118 between the amplifier 120 and the BTP 130.

Power for the BTP 130 is provided via power passing through the AC line 134 and an AC to DC power converter 172 and a power line 164. The power converter 172, although shown only in FIG. 4, is necessary in each of the embodiments to convert AC power in the network to DC power in the various BTP configurations. However, the converter 172 is often integrated into the BTP, and therefore, is not shown as a separate component in the other embodiments.

At the downstream end of the BTP 130, the AC line 134 and the RF line 136 are rejoined by a diplexer 138 and exits downstream in the branch 118. This embodiment of the present invention provides the same functionality as the embodiment shown in FIG. 2 and does not require the modification of a tap 22, but is likely to require plant recalibration or additional amplification due to the fact that two additional directional couplers are introduced into the network by this embodiment. Optionally, the strand mounted BTP 130 may include an internal upstream and/or downstream amplifier (not shown) for unity gain.

A second alternative embodiment of the present invention is shown in FIG. 5, and comprises a modified node 216. The modified node 216 includes a built-in BTP 230. As is conventional, the node 216 converts light travelling through the fiber-optic line 214 into electrical signals, splits the line into multiple coaxial branches 218, and provides amplification to the downstream signals. The inclusion of four branches 218 is intended to be exemplary. Other numbers of branches 218 are, of course, possible.

The fiber-optic line 214 is connected to a fiber-optic receiver 282 and a fiber-optic transmitter 280. The fiber optic receiver 282 converts downstream optical signals to electronic signals, which exit the receiver 282 through a coaxial line 286. The coaxial line 286 is then divided into four lines 286 by a series of splitters 242. An amplifier 278 is typically located on each of the four lines 286 to boost downstream signal strength. After amplification, each of the downstream coaxial lines 286 passes through a diplexer 238 and exits the node 216 in one of the branches 218.

Upstream electrical signals enter the node 216 through one of the four branches 218, pass through a diplexer 238 (which separates them from the downstream signals), and one of four upstream coaxial lines 284. The four upstream coaxial lines 284 are joined into a single coaxial line 284 by splitters 242. The fiber-optic transmitter 280 then converts the upstream electrical signal into an optical signal, which exits the transmitter 280 through the fiber-optic line 214.

In accordance with the present invention, the node 216 includes a BTP 230 having an ingress-monitoring interface 260 and a modem 262. A downstream-facing directional coupler 240 is located on each of the downstream signal coaxial lines 286 downstream from the splitters 242. Each downstream-facing directional coupler 240 is connected to the ingress monitoring interface 260 by a line 276. This configuration enables the ingress monitoring interface to monitor ingress downstream from the node 216 in each of the four branches 218 individually. The upstream-facing directional coupler 256 is preferably located on the coaxial line 284 between the splitters 242 and the transmitter 280 and is connected by a line 258 to the modem 262. Power for the BTP 230 is preferably provided internally by the node 216 via power passing.

FIG. 6 shows the incorporation of a BTP 330 into an amplifier 320. In the amplifier 320, forward and reverse amplifiers 382, 380 are substituted for the fiber-optic receiver and transmitter 282, 280, respectively, since signals enter and exit the amplifier 320 through coaxial branches 318. The amplifier 320 is otherwise very similar in structure to the node 216 and therefore will not be described in detail.

Due to the number of directional couplers that the embodiments shown in FIGS. 5 & 6 would add to an HFC network and the cost of replacing nodes and amplifiers, these embodiments are most suitable for use when installed in a new network as opposed to being retrofitted into an existing one.

While the principles of the invention have been described above in connection with specific apparatus, it is to be clearly understood that this description is made only by way of example and not as a limitation on the scope of the invention.

What is claimed is:

1. A system for monitoring ingress in an HFC network having a hub, a domain manager located for monitoring the status of the HFC network, a fiber-optic line, and a node located along the fiber-optic line, the monitoring system comprising:
a BTP remotely located at or downstream from the node, the BTP including an ingress monitoring interface connected to the HFC network to detect ingress in the HFC network downstream from the interface and a modem in communication with the domain manager to transmit detected ingress information.

2. The system of claim 1, wherein the HFC network further includes a tap connected to the HFC network and located downstream from the node, and the ingress-monitoring interface and modem are connected to the HFC network at the tap.

3. The system of claim 2, wherein the tap includes an upstream-facing directional coupler and a downstream-facing directional coupler, the ingress-monitoring interface being connected to the downstream-facing directional coupler and the modem being connected to the upstream-facing directional coupler.

4. The system of claim 3, wherein the upstream-facing directional coupler is located downstream from the downstream-facing directional coupler.

5. An HFC network having a hub, a plurality of lines to transmit RF signals, and a system for monitoring ingress, comprising:
a tap having an RF line to transmit RF signals, an upstream-facing directional coupler located on the RF line, and a downstream-facing directional coupler located on the RF line; and
a BTP including an ingress monitoring interface connected to the downstream-facing directional coupler to detect ingress in the HFC network downstream from the ingress monitoring interface and a modem to communicate with the domain manager to transmit detected ingress information.

6. The HFC network of claim 5, wherein the tap further includes an AC line for transmitting AC power, and the BTP receives AC power from the AC line.

7. The HFC network of claim 6, wherein the AC power is transmitted from the AC line to the BTP by a twisted pair.

8. The HFC network of claim 5, wherein the downstream-facing coupler is located upstream from the upstream-facing coupler.

9. The HFC network of claim 5, wherein the BTP is located within a building and receives AC power from the building.

10. The HFC network of claim 5, further comprising an amplifier located on the HFC network immediately upstream from the tap.

11. The HFC network of claim 5, wherein the plurality of lines comprise a fiber-optic line, a node coupled to the fiber-optic line, and at least one branch extending downstream from the node, and the tap is connected to the branch and located downstream from the node.

12. A system for monitoring ingress in an HFC network having a hub, a domain manager, and a plurality of lines to transmit RF signals, the system comprising:
a BTP adapted to be connected to the HFC network and located remotely with respect to the hub, the BTP including a downstream-facing directional coupler, an upstream-facing directional coupler, an ingress monitoring interface connected to the downstream-facing directional coupler to detect ingress in the network, and a modem connected to the upstream-facing directional coupler to communicate with the domain manager.

13. The system of claim 12, wherein the BTP further comprises a power conversion unit for converting AC power to DC power.

14. The system of claim 12, further comprising an amplifier located on the network immediately upstream from the BTP.

15. An HFC network having a system for monitoring ingress, comprising:
a node having a branch extending downstream therefrom, a fiber-optic line extending upstream therefrom, a downstream-facing directional coupler located on the branch, and an upstream-facing directional coupler; and
a BTP connected to the node and having an ingress-monitoring interface and a modem, the modem being connected to the upstream-facing directional coupler, and the ingress monitoring interface being connected to the downstream facing directional coupler to monitor ingress in the branch.

16. The HFC network of claim 15, wherein the upstream-facing directional coupler is located downstream from the downstream-facing directional coupler.

17. The HFC network of claim 15, wherein the node includes a plurality of branches and a downstream-facing directional coupler located on each branch, and the ingress monitoring interface is connected to each downstream-facing directional coupler to independently monitor ingress in each of the branches.

18. An HFC network having a system for monitoring ingress, comprising:
an amplifier having at least one branch extending downstream therefrom and a downstream-facing directional coupler located on the branch, and an upstream-facing directional coupler; and
a BTP connected to the node and having an ingress-monitoring interface and a modem, the modem being connected to the upstream-facing directional coupler, and the ingress monitoring interface being connected to the downstream facing directional coupler to monitor ingress in the branch.

19. The HFC network of claim 18, wherein the upstream-facing directional coupler is located downstream from the downstream-facing directional coupler.

20. The HFC network of claim 19, wherein the amplifier includes a plurality of branches and a downstream-facing directional coupler located on each branch, and the ingress monitoring interface is connected to each downstream-facing directional coupler to independently monitor ingress in each of the branches.
